(19) United States
(12) Patent Application Publication
(10) Pub. No.: US 2010/0218076 A1
(43) Pub. Date: Aug. 26, 2010

(54) DOCUMENT ANALYZING METHOD, DOCUMENT ANALYZING SYSTEM AND DOCUMENT ANALYZING PROGRAM

(76) Inventors: Kai Ishikawa, Tokyo (JP); Susumu Akamine, Tokyo (JP); Satoshi Nakazawa, Tokyo (JP); Toshio Takeda, Tokyo (JP)

Correspondence Address: FOLEY AND LARDNER LLP;SUITE 500, 3000 K STREET NW, WASHINGTON, DC, 20007, US

(21) Appl. No.: 12/738,592

(22) PCT Filed: Oct. 10, 2008
(86) PCT No.: PCT/JP2008/068425

§ 371 Date: Apr. 16, 2010

(51) Int. Cl. G06F 17/00

(52) U.S. Cl. 715/201

(57) ABSTRACT

To obtain a document group in which an assertion standpoint with respect to a proposition and a ground for the assertion are the same between documents constituting the document group without using an expression concerning opinions or grounds, etc., in a document. A document analyzing method comprising: determining whether a ground for the assertion with respect to a proposition is the same or not based on whether citation source documents in the form of an electronic document cited in electronic documents are common or not; and combining, based on the determination result, electronic documents including an assertion with respect to a given proposition, between which the assertion standpoint on whether to affirm or deny the proposition or whether to be in a neutral standpoint with respect to the proposition and a ground for the assertion standpoint are the same, into one group.

### TECHNICAL FIELD

The present invention relates to a document analyzing method, a document analyzing system, and a document analyzing program for analyzing an electronic document.

### BACKGROUND ART

If a user who needs to verify a given proposition can refer to document information including opinions of various senders on the proposition, he or she can deeply understand the proposition and accurately judge true or false of the proposition.

Document information on a computer network (e.g., Internet) created by various senders is extremely useful in terms of being capable of easily providing a large volume of reference information. On the other hand, however, the reference information has no guarantee for reliability or quality, so that a user needs to use his or her own judgment as to the reliability or quality of the information when utilizing the information.

There has been proposed a method for reducing a burden on the user who needs to judge the reliability or quality of information one by one when utilizing information on a computer network. For example, NPL 1 discloses a method that classifies documents that a user collects based on a topic word that he or she inputs in terms of opinions or grounds on a proposition for presentation to the user.

The method disclosed in NPL 1 uses a technique that automatically determines the sameness between description contents based on expressions such as opinions or grounds in the documents. With this method, it is possible to generate document groups each describing the same opinion or ground. Further, classifying the documents based on the same opinions and grounds for presentation allows a user to view information in units of a group and to judge the reliability or quality of information in units of a group, resulting in a reduction of a burden on the user.

NPL 1: H. Miyamori, et. al., “Evaluation Data and Prototype System WISDOM for Information Credibility Analysis”, In Proc. of First International Symposium on Universal Communication (2007), pp. 234-237

### SUMMARY OF INVENTION

### Technical Problem

However, in the related method disclosed in NPL 1, a method of automatically accurately determining the sameness between the description contents based on expressions such as opinions or grounds in the documents has not been established. Therefore, even if the related method disclosed in NPL 1 is used, there is a possibility that the automatic generation of groups each describing the same opinion or ground cannot be achieved with sufficient accuracy.

For example, there is known, as the method of automatically determining the sameness between the description contents based on expressions in the documents, a method of determining a synonymous expression based on a flexible predicate argument structure matching. The synonymous expression determination method can determine the sameness between the description contents only when a difference between expressions to be determined is in a synonymous expression level. However, when the difference between the target expressions is actually determined, not only a determination at the synonymous expression level but also a determination based on higher-level meaning understanding such as prerequisite knowledge or logical deduction is often required in the sameness determination.

For example, assumed is a case where the sameness is determined between the following two expressions representing grounds: “since isoflavone has a function of increasing the amount of DHEAs having an effect of accelerating fat combustion” and “isoflavone or DHEA has diet effect”. In this case, in order to determine the sameness between the above two expressions, it is necessary to perform deduction using prerequisite knowledge such as “diet effect is caused by acceleration of fat combustion in a body” or “diet effect is caused by an increase of a substance having an effect of accelerating fat combustion in a body”. Further, in the case where a description of the ground is not clear or a description of the ground itself does not exist, the sameness between expressions cannot be determined.

An object of the present invention is therefor to provide a document analyzing method, a document analyzing system, and a document analyzing program capable of obtaining a document group in which an assertion standpoint with respect to a proposition and a ground for the assertion are the same between documents constituting the document group without using an expression concerning opinions or grounds, etc., in a document.

### Solution to Problem

A document analyzing method according to an aspect of the present invention comprises: determining whether a ground for the assertion with respect to a proposition is the same or not based on whether citation source documents in the form of an electronic document cited in electronic documents are common or not; and combining, based on the determination result, electronic documents including an assertion standpoint with respect to a given proposition, between which the assertion standpoint on whether to affirm or deny the proposition or whether to be in a neutral standpoint with respect to the proposition and a ground for the assertion standpoint are the same, into one group.

A document analyzing method according to another aspect of the present invention comprises: determining whether a ground for the assertion with respect to a proposition is the same or not based on whether reference source documents in the form of an electronic document referred to when electronic documents are created are common or not; and combining, based on the determination result, electronic documents including an assertion standpoint with respect to a given proposition, between which the assertion standpoint on whether to affirm or deny the proposition or whether to be in a neutral standpoint with respect to the proposition and a ground for the assertion standpoint are the same, into one group.

A document analyzing method according to still another aspect of the present invention comprises: determining whether a ground for the assertion with respect to a proposition is the same or not based on whether at least one of citation source documents in the form of an electronic document cited in electronic documents and reference source documents in the form of an electronic document referred to when electronic documents are created are common or not; and combining, based on the determination result, electronic documents including an assertion standpoint with respect to a given proposition, between which the assertion standpoint on whether to affirm or deny the proposition or whether to be in a neutral standpoint with respect to the proposition and a ground for the assertion standpoint are the same, into one group.

A document analyzing system according an aspect of the present invention comprises: an assertion ground determination unit that determines whether a ground for the assertion with respect to a proposition is the same or not based on whether citation source documents in the form of an electronic document cited in electronic documents are common or not, wherein based on the determination result, the document analyzing system combines electronic documents including an assertion standpoint with respect to a given proposition, between which the assertion standpoint on whether to affirm or deny the proposition or whether to be in a neutral standpoint with respect to the proposition and a ground for the assertion standpoint are the same, into one group.

A document analyzing system according to another aspect of the present invention comprises: an assertion ground determination unit that determines whether a ground for the assertion with respect to a proposition is the same or not based on whether reference source documents in the form of an electronic document referred to when electronic documents are created are common or not, wherein based on the determination result, the document analyzing system combines electronic documents including an assertion standpoint with respect to a given proposition, between which the assertion standpoint on whether to affirm or deny the proposition or whether to be in a neutral standpoint with respect to the proposition and a ground for the assertion standpoint are the same, into one group.

A document analyzing system according to still another aspect of the present invention comprises: an assertion ground determination unit that determines whether a ground for the assertion with respect to a proposition is the same or not based on whether at least one of citation source documents in the form of an electronic document cited in electronic documents and reference source documents in the form of an electronic document referred to when electronic documents are created are common or not, wherein based on the determination result, the document analyzing system combines electronic documents including an assertion standpoint with respect to a given proposition, between which the assertion standpoint on whether to affirm or deny the proposition or whether to be in a neutral standpoint with respect to the proposition and a ground for the assertion standpoint are the same, into one group.

A document analyzing program according to an aspect of the present invention allows a computer to execute: determining whether a ground for the assertion with respect to a proposition is the same or not based on whether citation source documents in the form of an electronic document cited in electronic documents are common or not; and combining, based on the determination result, electronic documents including an assertion standpoint with respect to a given proposition, between which the assertion standpoint on whether to affirm or deny the proposition or whether to be in a neutral standpoint with respect to the proposition and a ground for the assertion standpoint are the same, into one group.

A document analyzing program according to another aspect of the present invention allows a computer to execute: determining whether a ground for the assertion with respect to a proposition is the same or not based on whether reference source documents in the form of an electronic document referred to when electronic documents are created are common or not; and combining, based on the determination result, electronic documents including an assertion standpoint with respect to a given proposition, between which the assertion standpoint on whether to affirm or deny the proposition or whether to be in a neutral standpoint with respect to the proposition and a ground for the assertion standpoint are the same, into one group.

A document analyzing program according to still another aspect of the present invention allows a computer to execute: determining whether a ground for the assertion with respect to a proposition is the same or not based on whether at least one of citation source documents in the form of an electronic document cited in electronic documents and reference source documents in the form of an electronic document referred to when electronic documents are created are common or not; and combining, based on the determination result, electronic documents including an assertion standpoint with respect to a given proposition, between which the assertion standpoint on whether to affirm or deny the proposition or whether to be in a neutral standpoint with respect to the proposition and a ground for the assertion standpoint are the same, into one group.

### ADVANTAGEOUS EFFECTS OF INVENTION

According to the present invention, it is possible to obtain a document group in which an assertion standpoint with respect to a proposition and a ground for the assertion are the same between documents constituting the document group without using an expression concerning opinions or grounds, etc., in a document.

### BRIEF DESCRIPTION OF DRAWINGS

FIG. 1 A block diagram showing an example of a configuration (module configuration) of a document analyzing system according to the present invention.

FIG. 2 A flowchart showing a flow of processing that the document analyzing system executes.

FIG. 3 An explanatory view showing an example of a proposition text.

FIG. 4 An explanatory view showing an example of proposition relevant document meta information.

FIG. 5 An explanatory view showing an example of a proposition relevant document text.

FIG. 6 An explanatory view showing an example of proposition relevant document meta information.

FIG. 7 An explanatory view showing an example of a releasing information group generation method.

FIG. 8 An explanatory view showing an example of releasing information groups obtained within proposition relevant documents.

FIG. 9 A block diagram showing a minimum configuration example of the document analyzing system.

### REFERENCE SIGNS LIST

100: Input device
200: Output device
300: Computer
301: Proposition relevant document group registration unit
302: Proposition relevant document group generation unit
303: Proposition relevant document group output unit
400: Storage medium
401: Proposition relevant document meta information storage unit
402: Proposition relevant document text storage unit

### DESCRIPTION OF EMBODIMENTS

An exemplary embodiment of the present invention will be described below with reference to the accompanying drawings. A document analyzing system according to the present invention performs processing of combining electronic documents including an assertion standpoint with respect to a given proposition, between which the assertion standpoint on whether to affirm or deny the proposition or whether to be in a neutral standpoint with respect to the proposition and a ground for the assertion standpoint are the same, into one group. In the present invention, a document analyzing system is featured in that when a user verifies a given proposition (for example, a matter, such as a description saying “Natto has diet effect”, whose authenticity can be discussed), the document analyzing system classifies document information (electronic documents) including opinions of various senders on the proposition in terms of the content of the opinions or grounds for presentation to the user to thereby support user's verification of the proposition. In the present exemplary embodiment, “proposition” means a matter whose authenticity can be questioned.

The document analyzing system using a document analyzing method according to the present invention does not use an expression concerning opinions or grounds, etc., in a document but focuses on citation or reference information corresponding to the grounds for the assertion with respect to the proposition to thereby determine the sameness between the grounds. That is, when the citation or reference information with respect to descriptions of opinions between two documents are consistent with each other, the document analyzing system determines that the grounds of both the two documents are the same. In this case, the citation or reference information corresponds to information referred to at the time of description of the opinions in the document or information cited in the descriptions of the opinions and grounds for the opinions.

In the following, there may be a case where the citation or reference information is explained as a document (citation source document or reference source document). The entity of the citation or reference information is not limited to a text but may be media information such as voice or image, as long as the information can form an opinion concerning a proposition in a document.

For example, assuming that there is a citation description saying “NKK seven o'clock news on 3 May said . . . ”, “NKK seven o'clock news” in this description corresponds to the citation information. Further, in the case where a plurality of citation information or reference information exist when determining the consistency between the citation or reference information, the document analyzing system not only determines the consistency for the individual citation or reference information but also for a combination thereof. Further, the document analyzing system regards also information cited or referred to recursively from the citation or reference information as a target of determination on the consistency, as with other citation or reference information.

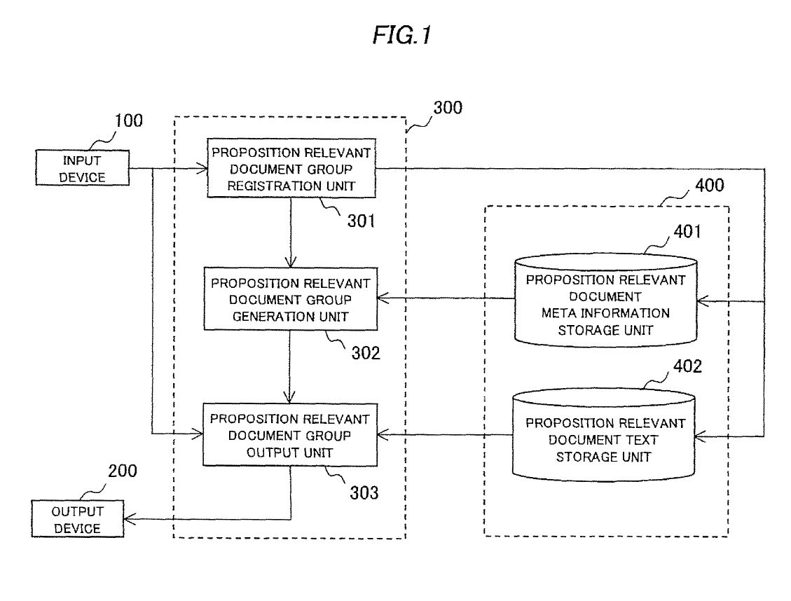

A configuration of the document analyzing system will next be described. FIG. 1 is a block diagram showing an example of a configuration (module configuration) of the document analyzing system according to the present invention. As shown in FIG. 1, the document analyzing system includes an input device 100, an output device 200, a computer (central processing unit (CPU); processor; data processing device) 300 that operates under control of a program, and a storage medium 400.

The input device 100 is realized by an input device such as a keyboard or mouse and inputs various information according to user's operation. Alternatively, the input device 100 may be realized by, e.g., a network interface section of an information processing device such as a personal computer. In this case, the input device 100 inputs various information via a communication network such as the Internet. Further alternatively, the input device 100 may be realized by, e.g., an input/output section of the information processing device. In this case, the input device 100 extracts various information from a database that the information processing device has.

The output device 200 has a function of outputting various information according to an instruction from the computer 300. The output device 200 is realized by, e.g., a presentation device such as a display and displays various information according to an instruction from the computer 300. Alternatively, the output device 200 may be realized by, e.g., a printing device such as a printer. In this case, the output device 200 prints out various information according to an instruction from the computer 300. Further alternatively, the output device 200 may be realized by, e.g., a network interface section of an information processing device. In this case, the output device 200 outputs, as a file, various information via a communication network such as Internet. Still further alternatively, the output device 200 may be realized by, e.g., an input/output section of an information processing device. In this case, the output device 200 outputs, as a file, various information to a database that the information processing device has.

The computer (CPU; processor; data processing device) 300 includes a proposition relevant document group registration unit 301, a proposition relevant document group generation unit 302, and a proposition relevant document group output unit 303. These units 301 to 303 operate as follows.

The proposition relevant document group registration unit 301 is, concretely, a unit realized by the computer 300 executing the processing thereof according to a program. The proposition relevant document group registration unit 301 has a function of inputting, via the input device 100, proposition relevant document meta information and a proposition relevant document text. The “proposition relevant document text” is text data of an electronic document including the content relevant to a given proposition. The “proposition relevant document meta information” is meta information (information indicating various attributes of the “proposition relevant document text”) added to the proposition relevant document text.

For example, the proposition relevant document group registration unit 301 inputs, via the input device 100, a document text of an electronic document (hereinafter, referred to as “proposition directly-relevant document”) directly relevant (e.g., including an opinion with respect to a given proposition) to a proposition as the proposition relevant document text. Further, for example, the proposition relevant document group registration unit 301 inputs, via the input device 100, a document text of a citation source document or a document text of a reference source document as the proposition relevant document text. The “citation source document” is a document cited in the proposition relevant document text (proposition directly-relevant document, reference source document, or other citation source document). The “reference source document” is a document referred to when the proposition relevant document text (proposition directly-relevant document, citation source document, or other reference source document) is created.

Further, the proposition relevant document group registration unit 301 has a function of registering the input proposition relevant document meta information in the storage medium 400 (to be more precise, a proposition relevant document meta information storage unit 401 to be described later). Furthermore, the proposition relevant document group registration unit 301 has a function of registering the input proposition relevant document text in the storage medium 400 (to be more precise, a proposition relevant document text storage unit 402 to be described later). The proposition relevant document group registration unit 301 generates a document ID that can identify the input proposition relevant document text and stores the proposition relevant document meta information in the storage medium 400 in association with the generated document ID. Further, the proposition relevant document group registration unit 301 stores the proposition relevant document text in the storage medium 400 in association with the generated document ID.

The proposition relevant document group generation unit 302 is, concretely, a unit realized by the computer 300 executing the processing thereof according to a program. The proposition relevant document group generation unit 302 has a function of determining whether a ground for the assertion with respect to a proposition is the same based on whether citation source documents cited in electronic documents are common or not. Furthermore, the proposition relevant document group generation unit 302 has a function of determining whether a ground for the assertion with respect to a proposition is the same based on whether reference source documents referred to when electronic documents are created are common or not. Furthermore, the proposition relevant document group generation unit 302 has a function of determining whether a ground for the assertion with respect to a proposition is the same based on whether citation source documents cited in electronic documents and reference source documents referred to when the electronic documents are created are common or not. In addition, the proposition relevant document group generation unit 302 has a function of generating a group including, as a proposition relevant document relevant to a proposition, electronic documents in which a ground for the assertion with respect to the proposition is determined to be the same.

More concretely, the proposition relevant document group generation unit 302 combines releasing information (proposition relevant document texts) having similar proposition relevant document meta information into a group based on the proposition relevant document meta information stored in the proposition relevant document meta information storage unit 401 to thereby generate a releasing information group. The proposition relevant document group generation unit 302 outputs the generated releasing information group to the proposition relevant document group output unit 303.

For example, the proposition relevant document group generation unit 302 determines whether citation source documents cited in electronic documents are common or not based on the proposition relevant document meta information (i.e., proposition relevant document meta information that the proposition relevant document group registration unit 301 has input) stored in the proposition relevant document meta information storage unit 401. Then, when determining that the citation source documents are common, the proposition relevant document group generation unit 302 determines that a ground for the assertion with respect to a proposition is the same.

Further, for example, the proposition relevant document group generation unit 302 determines whether reference source documents referred to when electronic documents are created are common or not based on the proposition relevant document meta information (i.e., proposition relevant document meta information that the proposition relevant document group registration unit 301 has input) stored in the proposition relevant document meta information storage unit 401. Then, when determining that the reference source documents are common, the proposition relevant document group generation unit 302 determines that a ground for the assertion with respect to a proposition is the same.

Further, for example, the proposition relevant document group generation unit 302 determines whether citation source documents cited in electronic documents are common or not based on the proposition relevant document meta information (i.e., proposition relevant document meta information that the proposition relevant document group registration unit 301 has input) stored in the proposition relevant document meta information storage unit 401, as well as determines whether reference source documents referred to when electronic documents are created are common or not based on the proposition relevant document meta information stored in the proposition relevant document meta information storage unit 401. When determining that the citation source documents and reference source documents are common respectively, the proposition relevant document group generation unit 302 determines that a ground for the assertion with respect to a proposition is the same.

The proposition relevant document group generation unit 302 may determine whether a ground for the assertion with respect to a proposition is the same based on whether citation source documents further citing a citation source document or reference source document and reference source documents further referred to when a citation source document or reference source document is created are common or not.

The proposition relevant document group output unit 303 is, concretely, a unit realized by the computer 300 executing the processing thereof according to a program. The proposition relevant document group output unit 303 has a function of making the output device 200 output the proposition relevant document group (releasing information group) generated and output by the proposition relevant document group generation unit 302. Further, the proposition relevant document group output unit 303 has a function of generating a list of document IDs that can identify the proposition relevant document texts constituting the releasing information group and making the output device 200 output the list.

Further, the proposition relevant document group output unit 303 has a function of acquiring (extracting), when receiving a display request of a proposition relevant document text having a given document ID, a proposition relevant document text corresponding to the received document ID from the proposition relevant document text storage unit 402. Furthermore, the proposition relevant document group output unit 303 has a function of making the output device 200 output the extracted proposition relevant document text.

In addition to the functions implement in the present exemplary embodiment, the document analyzing system may be configured to allow a user to utilize a set of proposition relevant document meta information used in generation of the releasing information group. Further, the document analyzing system may be configured to allow a user to narrow down the number of proposition relevant document texts constituting the releasing information group based on a condition concerning the proposition relevant document meta information. Furthermore, the document analyzing system may be configured to use an ontology concerning the citation and reference documents of the proposition relevant document meta information when grouping the releasing information.

For example, the document analyzing system may have a unit for inputting, via the input device 100, information specifying a set of proposition relevant document meta information, information specifying a condition concerning the proposition relevant document meta information, or information specifying an ontology concerning the citation and reference documents according to user's operation. Then, the proposition relevant document group generation unit 302 may generate the releasing group based on the input information and proposition relevant document meta information stored in the proposition relevant document meta information storage unit 401.

Further, for example, the document analyzing system may have a unit for specifying a specific citation source document or reference source document according to user's specification operation and may be configured to input specifying information of the citation or reference source document specified by the user. In this case, the proposition relevant document group output unit 303 may extract a releasing information group including proposition relevant documents whose assertion with respect to a proposition has been determined to be the same based on the citation source or reference source document specified by a user from among the plurality of releasing information groups generated by the proposition relevant document group generation unit 302 and delete the extracted releasing information group from the output information. Further, when a specific citation or reference source document is specified, the proposition relevant document group output unit 303 may extract only a group including proposition relevant documents whose assertion with respect to a proposition has been determined to be the same based on the specified citation source or reference source document from a set of electronic documents including assertions with respect to a proposition and output the extracted group.

The storage medium 400 is, concretely, realized by a storage device such as a magnetic disk drive or optical disk drive. The storage medium 400 includes the proposition relevant document meta information storage unit 401 and document text storage unit 402. These units store the following information.

The proposition relevant document meta information storage unit 401 stores the proposition relevant document meta information registered by the proposition relevant document group registration unit 301. The proposition relevant document meta information storage unit 401 stores the proposition relevant document meta information in association with the document ID that can identify the proposition relevant document text.

The document text storage unit 402 stores the proposition relevant document text registered by the proposition relevant document group registration unit 301. The document text storage unit 402 stores, as the proposition relevant document text, a document text of the proposition directly-relevant document, citation source document, or reference source document. Further, the document text storage unit 402 stores the proposition relevant document text in association with the document ID that can specify the proposition relevant document text.

In the present exemplary embodiment, a storage device (e.g., a hard disk drive or memory that an information processing device such as a personal computer has) that the document analyzing system has stores various programs for analyzing electronic documents such as the proposition relevant document, citation source document, and reference source document. For example, the storage device that the document analyzing system has stores a document analyzing program for allowing a computer to execute a processing of determining whether a ground for the assertion with respect to a proposition is the same based on whether citation source documents in the form of an electronic document cited in electronic documents are common or not. Further, for example, the storage device that the document analyzing system has stores a document analyzing program for allowing a computer to execute a processing of determining whether a ground for the assertion with respect to a proposition is the same based on whether reference source documents in the form of an electronic document referred to when electronic documents are created are common or not. Further, for example, the storage device that the document analyzing system has stores a document analyzing program for allowing a computer to execute a processing of determining whether a ground for the assertion with respect to a proposition is the same based on whether at least one of citation source documents in the form of an electronic document cited in electronic documents and reference source documents in the form of an electronic document referred to when electronic documents are created are common or not.

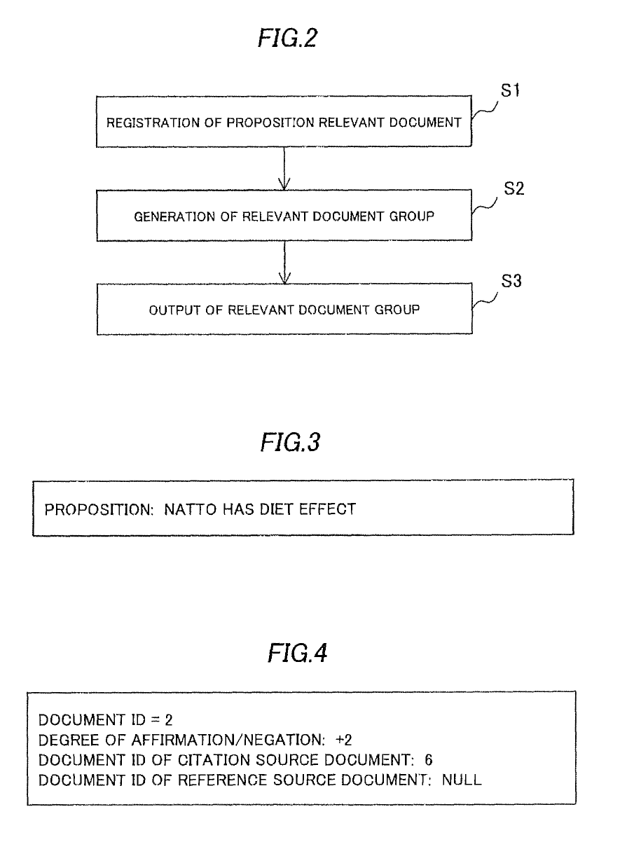

Next, operation will be described. FIG. 2 is a flowchart showing a flow of processing that the document analyzing system executes. The proposition relevant document group registration unit 301 inputs, via the input device 100, the proposition relevant document meta information and proposition relevant document text. For example, the proposition relevant document group registration unit 301 inputs the proposition relevant document meta information and proposition relevant document text via the input device 100 according to user's input operation. Then, the proposition relevant document group registration unit 301 registers the input proposition relevant document meta information in the proposition relevant document meta information storage unit 401. Further, the proposition relevant document group registration unit 301 stores the input proposition relevant document text in the proposition relevant document text storage unit 402 (step S1 of FIG. 2).

In step S1, the proposition relevant document group registration unit 301 generates a document ID that can identify the proposition relevant document meta information and stores the proposition relevant document meta information in the proposition relevant document meta information storage unit 401 in association with the generated document ID. Further, the proposition relevant document group registration unit 301 stores the proposition relevant document text in the proposition relevant document text storage unit 402 in association with the generated document ID.

The proposition relevant document group registration unit 301 repeatedly executes the processing of step S1 every time the proposition relevant document meta information is input from the input device 100 to accumulate the proposition relevant document meta information in the proposition relevant document meta information storage unit 401. Further, the proposition relevant document group registration unit 301 repeatedly executes the processing of step S1 every time the proposition relevant document text is input from the input device 100 to accumulate the proposition relevant document text in the document text storage unit 402.

Then, the proposition relevant document group generation unit 302 combines releasing information (proposition relevant document texts) having similar proposition relevant document meta information into a group based on the proposition relevant document meta information stored in the proposition relevant document meta information storage unit 401 to thereby generate a releasing information group (step S2). For example, when receiving a releasing information group generation instruction from the input device 100 according to user's instruction operation, the proposition relevant document group generation unit 302 generates the releasing information group. Alternatively, for example, the proposition relevant document group generation unit 302 may periodically extract the proposition relevant document meta information accumulated in the proposition relevant document meta information storage unit 401 to generate the releasing information group.

Then, the proposition relevant document group generation unit 302 outputs the generated releasing information group to the proposition relevant document group output unit 303.

Subsequently, the proposition relevant document group output unit 303 makes the output device 200 output the proposition relevant document group (releasing information group) generated and output by the proposition relevant document group generation unit 302 (step S3). Further, the proposition relevant document group output unit 303 generates a list of the document IDs that can identify the proposition relevant document texts constituting the releasing information group and makes the output device 200 output the list.

When receiving a display request of a proposition relevant document text having a given document ID via the input device 100, the proposition relevant document group output unit 303 acquires (extracts) a proposition relevant document text corresponding to the received document ID from the proposition relevant document text storage unit 402. After that, the proposition relevant document group output unit 303 makes the output device 200 output the extracted proposition relevant document text.

As described above, according to the present exemplary embodiment, a document group in which an assertion standpoint with respect to a proposition and a ground for the assertion are the same between documents constituting the document group can be obtained. That is, according to the present exemplary embodiment, the document analyzing system using a document analyzing method does not use an expression concerning opinions or grounds, etc., in a document but focuses on citation or reference information corresponding to the grounds for the assertion to thereby determine the sameness between the grounds. Then, the document analyzing system classifies the proposition relevant documents into groups based on the determination result on the sameness between the grounds for the assertion with respect to the proposition.

According to the present exemplary embodiment, by performing the grouping as described above, it is possible to reduce the difficulty of not being able to perform automatic generation of the document group due to lack of establishment of a method that makes automatic determination of the sameness between description contents on the expression concerning opinions or grounds, etc., in a document with accuracy. Further, it is possible to prevent a problem that the sameness cannot be determined in the case where a description of the ground is not clear or a description of the ground itself does not exist. Therefore, it is possible to obtain a document group in which an assertion standpoint with respect to a proposition and a ground for the assertion are the same between documents constituting the document group without using an expression concerning opinions or grounds, etc., in a document.

For example, in the case where a determination method of the sameness between description contents disclosed in NPL 1 is used, if a difference between expressions in the electronic documents is beyond a synonymous level, the determination of the sameness cannot be made and the grouping of the documents cannot be achieved. Thus, in the case where the sameness cannot be determined unless deduction using prerequisite knowledge is performed or where a description of the document is not clear, the grouping of the documents cannot be achieved. On the other hand, according to the present exemplary embodiment, the document analyzing system does not use an expression concerning opinions or grounds, etc., in a document but focuses on citation or reference information corresponding to the grounds for the assertion to thereby determine the sameness between the grounds, thus making it possible to determine the sameness by performing deduction using prerequisite knowledge as well as making it possible to determine the sameness even in the case where a description in the document is not clear to allow grouping of the documents.

### EXAMPLE

A concrete example of the present invention will be described with reference to the accompanying drawings. As shown in FIG. 3, in the present example, assumed is a case where a user collects and analyzes a proposition relevant document text including a proposition “Natto has diet effect”. Hereinafter, an operation in which the document analyzing system collects and analyzes a proposition relevant document text including a proposition “Natto has diet effect” will be described.

The user previously collects, by using the document analyzing system (to be more precise, an information processing device such as a personal computer), documents (e.g., proposition directly-relevant documents) relevant to the proposition, citation source documents cited in the documents, and reference source documents referred to when the documents are created. The document analyzing device inputs, via the input device 100, the proposition relevant documents including the proposition directly-relevant documents, citation source documents, and reference source documents according to user's operation.

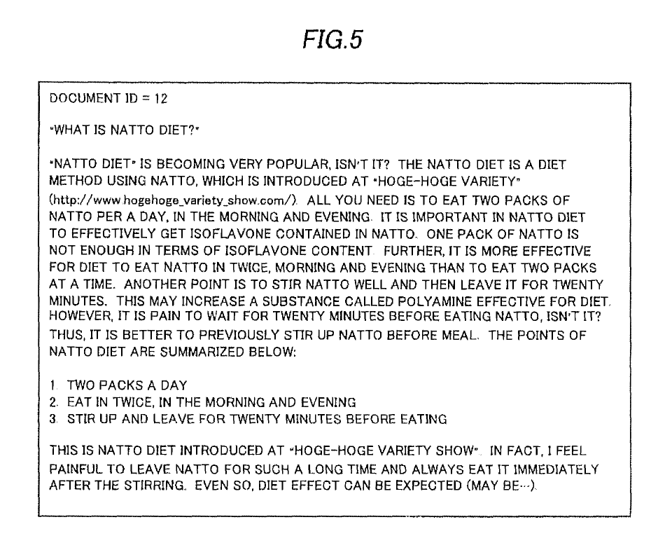

The document analyzing system previously creates the proposition relevant document meta information and proposition relevant document text for each of the collected proposition relevant documents according to user's operation. For example, the document analyzing system previously creates the proposition relevant document meta information (see FIG. 4) for one collected proposition relevant document (e.g., document having a document ID=12). Further, for example, the document analyzing system previously creates the proposition relevant document text (see FIG. 5) for one collected proposition relevant document (e.g., document having a document ID=12).

FIG. 4 is an explanatory view showing an example of the proposition relevant document meta information for the proposition relevant document (in this example, a proposition relevant document having an document ID=12).

As shown in FIG. 4, the proposition relevant document meta information includes “degree of affirmation/negation” corresponding to the standpoint (standpoint indicating whether the content of the proposition relevant document is affirmative or negative with respect to the proposition) with respect to the proposition. Further, the proposition relevant document meta information includes the document ID that can identify the citation source document and document ID that can identify the reference source document.

A positive value of the “degree of affirmation/negation” included in the proposition relevant document meta information indicates that the assertion in the proposition relevant document is affirmative with respect to the proposition. A negative value of the “degree of affirmation/negation” indicates that the assertion in the proposition relevant document is negative with respect to the proposition. The “degree of affirmation/negation” is meta information having characteristics in which the larger the absolute value thereof, the larger the degree of affirmation or negation and, conversely, the smaller the absolute value thereof, the smaller the degree of affirmation or negation (which means approximating to neutrality).

Since the “degree of affirmation/negation” has a positive value in the example of FIG. 4, it is clear that the collected proposition relevant document includes affirmative content with respect to the proposition. Further, since the absolute value of the “degree of affirmation/negation” is 2, it is clear that the degree of affirmation is somewhat large (larger than in the case where the value of “degree of affirmation/negation” is “+1”).

“Document ID of citation source document” included in the proposition relevant document meta information indicates a document ID that can identify an electronic document (citation source document) cited in the collected proposition relevant document. In the example of FIG. 4, an electronic document having a document ID of 6 is cited in the collected proposition relevant document.

“Document ID of reference source document” included in the proposition relevant document meta information indicates a document ID that can identify an electronic document (reference source document) referred to when the collected proposition relevant document is created. Since the “document ID of reference source document” is NULL in the example of FIG. 4, it can be understood that there exists no electronic document referred to when the collected proposition relevant document is created.

The document analyzing system generates the proposition relevant document meta information shown in FIG. 4 e.g., according to user's input operation. Further, for example, the document analyzing system collects a document citation/reference history that records citation/reference documents used when the user creates a document according to user's operation and creates the proposition relevant document meta information based on the collected citation/reference history.

FIG. 5 is an explanatory view showing an example of the proposition relevant document text corresponding to the proposition relevant document (in this example, a document having an document ID=12). In the example of FIG. 5, the proposition relevant document text includes in its description a name of the citation source document “Hoge-hoge Variety”. The citation source document included in the proposition relevant document of FIG. 5 corresponds to the “document ID of citation source document” (in this example, a citation source document having an document ID=6) included in the proposition relevant document meta information shown in FIG. 4.

The document analyzing system generates the proposition relevant document text of FIG. 5 by extracting a text from the collected proposition relevant document and adding a document ID that can identify the proposition relevant document to the extracted text.

According to the above processing, the document analyzing system generates the proposition relevant document meta information and proposition relevant document text based on the collected proposition relevant document. A configuration may be adopted in which a different system from the document analyzing system is used to generate the proposition relevant document meta information and proposition relevant document text and the generated proposition relevant document meta information and proposition relevant document text are input to the document analyzing system.

Subsequently, according to user's operation, the proposition relevant document group registration unit 301 of the document analyzing system inputs, via the input device 100, the proposition relevant document meta information and proposition relevant document text collected and created according to the above processing. Then, the proposition relevant document group registration unit 301 registers the input proposition relevant document meta information in the proposition relevant document meta information storage unit 401 of the storage medium 400. Further, the proposition relevant document group registration unit 301 registers the input proposition relevant document text (document text of the proposition directly-relevant document, citation source document, or reference source document) in the document text storage unit 402 of the storage medium 400 (step S1 of FIG. 2).

The proposition relevant document group registration unit 301 repeatedly executes the processing of step S1 every time the proposition relevant document meta information is input from the input device 100 to accumulate the proposition relevant document meta information in the proposition relevant document meta information storage unit 401. Further, the proposition relevant document group registration unit 301 repeatedly executes the processing of step S1 every time the proposition relevant document text is input from the input device 100 to accumulate the proposition relevant document text in the document text storage unit 402.

Then, the proposition relevant document group generation unit 302 of the document analyzing system combines releasing information having similar proposition relevant document meta information into a group based on the proposition relevant document meta information stored in the proposition relevant document meta information storage unit 401 to thereby generate a releasing information group (step S2 of FIG. 2). For example, when receiving a releasing information group generation instruction from the input device 100 according to user's instruction operation, the proposition relevant document group generation unit 302 generates the releasing information group. Alternatively, for example, the proposition relevant document group generation unit 302 may periodically extract the proposition relevant document meta information accumulated in the proposition relevant document meta information storage unit 401 to generate the releasing information group.

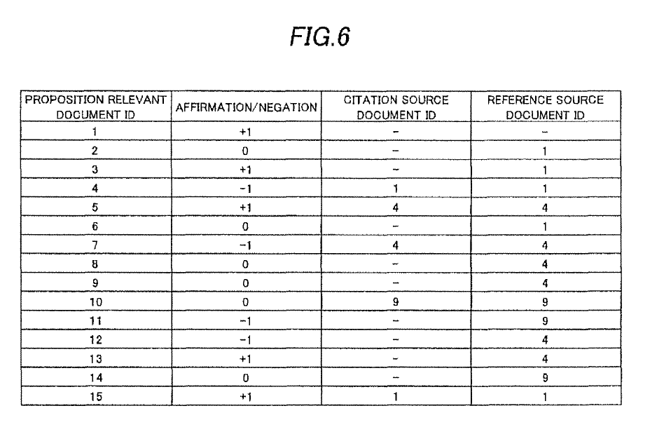

FIG. 6 is an explanatory view showing an example of the proposition relevant document meta information accumulated in the proposition relevant document meta information storage unit 401. It is assumed in the present example that the proposition relevant document meta information storage unit 401 stores the releasing information meta information (proposition relevant document meta information) shown in FIG. 6. In the present example, the proposition relevant document group generation unit 302 combines proposition relevant documents that share “citation source document ID” or “reference source document ID” and have the same value of “degree of affirmation/negation” into the same group to thereby generate one releasing information group.

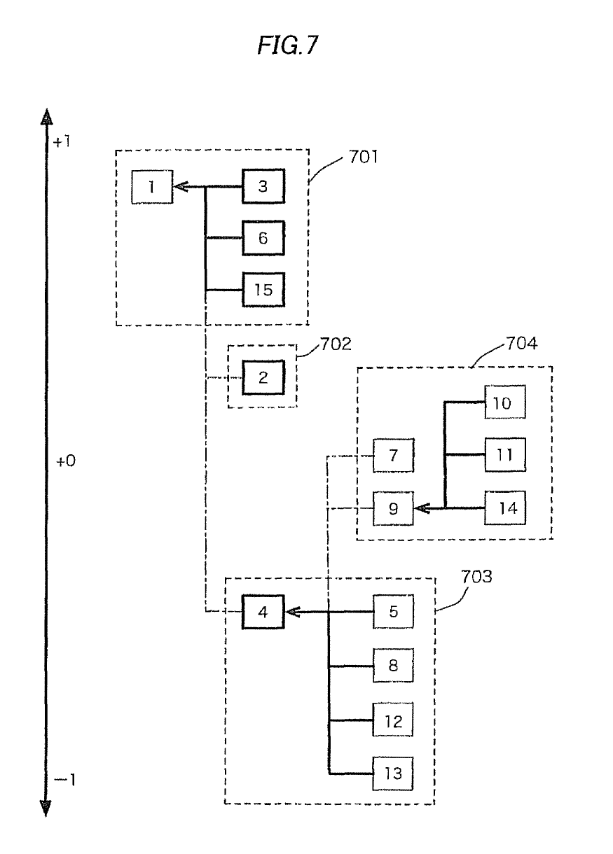

FIG. 7 is an explanatory view showing an example of a releasing information group generation method executed by the proposition relevant document group generation unit 302. In FIG. 7, a numbered node (box to which a number is assigned) represents the proposition relevant document meta information having a number as the document ID. A bold solid arrow of FIG. 7 connecting the numbered nodes represents that there is a relationship of citation or reference between documents having the same value of “degree of affirmation/negation”. Further, a broken arrow of FIG. 7 connecting the numbered nodes represents that there is a relationship of citation or reference between documents having the different values of “degree of affirmation/negation”. Further, in FIG. 7, broken squares 701, 702, 703, and 704 surrounding one numbered node or a plurality of numbered nodes each represent a releasing information group generated by the proposition relevant document group generation unit 302.

For example, in the example of the proposition relevant document meta information shown in FIG. 6, the proposition relevant document having a document ID of 1 is the citation source document or reference source document of the proposition relevant documents having document IDs of 3, 6, and 15 and the value of the “degree of affirmation/negation” is the same between the proposition relevant documents having document IDs of 1, 3, 6, and 15, so that, as shown in FIG. 7, a node 1 is connected to a node 3, node 6, and node 15 by bold solid lines. Concretely, the proposition relevant document group generation unit 302 performs processing of associating the nodes by adding, to the nodes 3, 6, and 15, link information to the node 1.

Further, for example, the proposition relevant document having a document ID of 4 is the citation source document or reference source document of the proposition relevant documents having document IDs of 5, 8, 12, and 13 and the value of the “degree of affirmation/negation” is the same between the proposition relevant documents having document IDs of 4, 5, 8 12, and 13 so that, as shown in FIG. 7, a node 4 is connected to a node 5, node 8, node 12, and, node 13 by bold solid lines. Concretely, the proposition relevant document group generation unit 302 performs processing of associating the nodes by adding, to the nodes 5, 8, 12, and 13, link information to the node 4.

Further, for example, the proposition relevant document having a document ID of 9 is the citation source document or reference source document of the proposition relevant documents having document IDs of 10, 11, and 14 and the value of the “degree of affirmation/negation” is the same between the proposition relevant documents having document IDs of 9, 10, 11, and 14, so that, as shown in FIG. 7, a node 9 is connected to a node 10, node 11, and node 14 by bold solid lines. Concretely, the proposition relevant document group generation unit 302 performs processing of associating the nodes by adding, to the nodes 10, 11, and 14, link information to the node 9.

Further, for example, the proposition relevant document having a document ID of 1 is the citation source document or reference source document of the proposition relevant documents having document IDs of 2 and 4 and the value of the “degree of affirmation/negation” is different between the proposition relevant documents having document IDs of 1, 2, and 4, so that, as shown in FIG. 7, a node 1 is connected to a node 2 and node 4 by broken lines. Concretely, the proposition relevant document group generation unit 302 performs processing of associating the nodes by adding, to the nodes 2 and 4, link information to the node 1.

Further, for example, the proposition relevant document having a document ID of 4 is the citation source document or reference source document of the proposition relevant documents having document IDs of 7 and 9 and the value of the “degree of affirmation/negation” is different between the proposition relevant documents having document IDs of 4, 7, and 9 so that, as shown in FIG. 7, a node 4 is connected to a node 7 and 9 by broken lines. Concretely, the proposition relevant document group generation unit 302 performs processing of associating the nodes by adding, to the nodes 7 and 9, link information to the node 4.

Then, the proposition relevant document group generation unit 302 combines numbers 1, 3, 6, and 15 into one releasing information group 701 as shown in FIG. 7 on the condition that the they have a relationship of citation or reference and has the same value of “degree of affirmation/negation”. Further, the proposition relevant document group generation unit 302 combines numbers 4, 5, 8, 12, and 13 into one releasing information group 703 as shown in FIG. 7 on the condition that they have a relationship of citation or reference and has the same value of “degree of affirmation/negation”. Further, the proposition relevant document group generation unit 302 combines numbers 7, 9, 10, 11, and 14 into one releasing information group 704 as shown in FIG. 7 on the condition that they have a relationship of citation or reference and has the same value of “degree of affirmation/negation”. Further, the proposition relevant document group generation unit 302 sets a node 2 between which and any of nodes the above conditions are not satisfied as a releasing group 702 by itself.

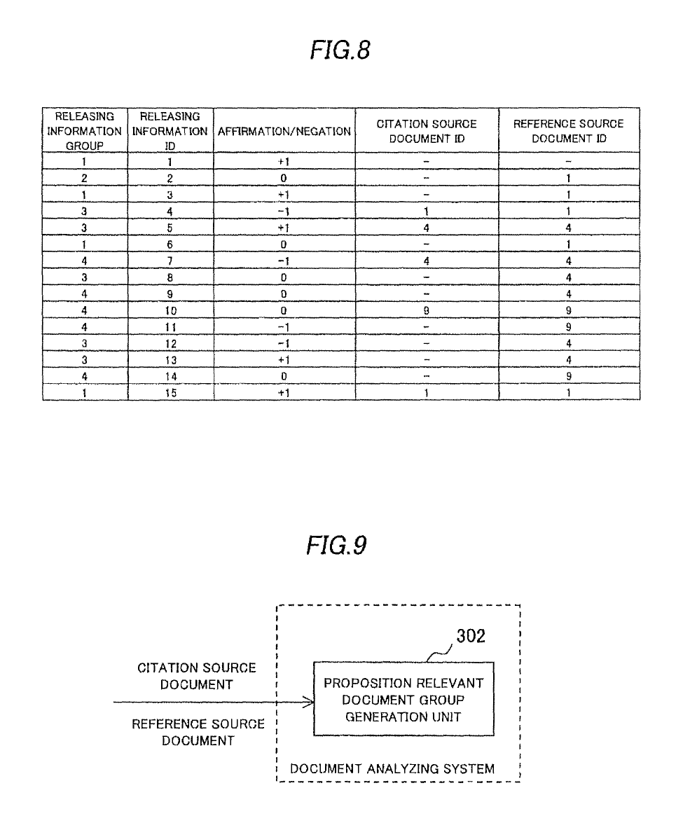

FIG. 8 is an explanatory view showing an example of releasing information groups obtained within the proposition relevant documents (in the present example, documents having document IDs of 1 to 32). As shown in FIG. 8, the proposition relevant document group generation unit 302 obtains (generates) releasing information groups 1 to 4 according to the generation method shown in FIG. 7. Then, the proposition relevant document group generation unit 302 outputs the generated releasing information groups to the proposition relevant document group output unit 303.

Then, the proposition relevant document group output unit 303 makes the output device 200 output the proposition relevant document groups (releasing information groups) generated and output by the proposition relevant document group generation unit 302 (step S3 of FIG. 2). Further, the proposition relevant document group output unit 303 generates a list of the document IDs that can identify the proposition relevant document texts constituting the releasing information groups and makes the output device 200 output the list.

When receiving a display request of a proposition relevant document text having a given document ID via the input device 100, the proposition relevant document group output unit 303 acquires (extracts) a proposition relevant document text corresponding to the received document ID from the proposition relevant document text storage unit 402 of the storage medium 400. After that, the proposition relevant document group output unit 303 makes the output device 200 output the extracted proposition relevant document text.

Next, a minimum configuration of the document analyzing system according to the present invention will be described. FIG. 9 is a block diagram showing a minimum configuration example of the document analyzing system. As shown in FIG. 9, the document analyzing system includes the proposition relevant document group generation unit 302 as a minimum constituent element.

The document analyzing system of FIG. 9 having the minimum configuration performs processing of combining electronic documents including an assertion standpoint with respect to a given proposition, between which the assertion standpoint on whether to affirm or deny the proposition or whether to be in a neutral standpoint with respect to the proposition and a ground for the assertion standpoint are the same, into one group.

Further, in the document analyzing system of FIG. 9 having the minimum configuration, the proposition relevant document group generation unit 302 has a function of determining whether a ground for the assertion with respect to a proposition is the same based on whether citation source documents cited in electronic documents are common or not. Furthermore, the proposition relevant document group generation unit 302 has a function of determining whether a ground for the assertion with respect to a proposition is the same based on whether reference source documents referred to when electronic documents are created are common or not. Furthermore, the proposition relevant document group generation unit 302 has a function of determining whether a ground for the assertion with respect to a proposition is the same based on whether citation source documents cited in electronic documents and reference source documents referred to when the electronic documents are created are common or not.

In the above exemplary embodiment and example, characteristic configurations of the document analyzing system as shown in the following (1) to (10) are obtained.

(1) The document analyzing system is a system that combines electronic documents including an assertion with respect to a given proposition, between which the assertion standpoint on whether to affirm or deny the proposition or whether to be in a neutral standpoint with respect to the proposition and a ground for the assertion standpoint are the same, into one group and is characterized by comprising an assertion ground determination unit (realized by, e.g., the proposition relevant document group generation unit 302) that determines whether a ground for the assertion with respect to a proposition is the same or not based on whether citation source documents in the form of an electronic document cited in electronic documents are common or not. With such a configuration, it is possible to determine the sameness between the grounds by focusing on citation source information and classify the electronic documents including the assertion with respect to the proposition into groups for the assertion with respect to a proposition based on the determination result on the sameness. Therefore, it is possible to obtain a document group in which an assertion standpoint with respect to a proposition and a ground for the assertion are the same between documents constituting the document group without using an expression concerning opinions or grounds, etc., in a document.

(2) The document analyzing system has a document attribute input unit (realized by, e.g., the proposition relevant document group registration unit 301) that inputs document attribute information (e.g., proposition relevant document meta information) representing the attribute of an electronic document including an assertion with respect to a proposition. The assertion ground determination unit determines whether citation source documents cited in electronic documents are common or not based on the document attribute information input by the document attribute input unit. When determining that citation source documents cited in electronic documents are common, the assertion ground determination unit may determine that a ground for the assertion with respect to a proposition is the same. With such a configuration, it is possible to easily determine whether citation source documents cited in electronic documents are common or not based on the document attribute information representing the attribute of an electronic document and thereby to easily determine whether a ground for the assertion with respect to a proposition is the same.

(3) The document analyzing system is a system that combines electronic documents including an assertion with respect to a given proposition, between which the assertion standpoint on whether to affirm or deny the proposition or whether to be in a neutral standpoint with respect to the proposition and a ground for the assertion standpoint are the same, into one group and is characterized by comprising an assertion ground determination unit (realized by, e.g., the proposition relevant document group generation unit 302) that determines whether a ground for the assertion with respect to a proposition is the same or not based on whether reference source documents in the form of an electronic document referred to when electronic documents are created are common or not. With such a configuration, it is possible to determine the sameness between the grounds for the assertion with respect to a proposition by focusing on reference source information and classify the electronic documents including the assertion with respect to the proposition into groups based on the determination result on the sameness. Therefore, it is possible to obtain a document group in which an assertion standpoint with respect to a proposition and a ground for the assertion are the same between documents constituting the document group without using an expression concerning opinions or grounds, etc., in a document.

(4) The document analyzing system has a document attribute input unit (realized by, e.g., the proposition relevant document group generation unit 302) that inputs document attribute information (e.g., proposition relevant document meta information) representing the attribute of an electronic document including an assertion with respect to a proposition. The assertion ground determination unit determines whether reference source documents referred to when electronic documents are created are common or not based on the document attribute information input by the document attribute input unit. When determining that reference source documents referred to when electronic documents are created are common, the assertion ground determination unit may determine that a ground for the assertion with respect to a proposition is the same. With such a configuration, it is possible to easily determine whether reference source documents referred to when electronic documents are created are common or not based on the document attribute information representing the attribute of an electronic document and thereby to easily determine whether a ground for the assertion with respect to a proposition is the same.

(5) The document analyzing system is a system that combines electronic documents including an assertion with respect to a given proposition, between which the assertion standpoint on whether to affirm or deny the proposition or whether to be in a neutral standpoint with respect to the proposition and a ground for the assertion standpoint are the same, into one group and is characterized by comprising an assertion ground determination unit (realized by, e.g., the proposition relevant document group generation unit 302) that determines whether a ground for the assertion with respect to a proposition is the same or not based on whether at least one of citation source documents in the form of an electronic document cited in electronic documents and reference source documents in the form of an electronic document referred to when electronic documents are created are common or not. With such a configuration, it is possible to determine the sameness between the grounds of the assertion with respect to the proposition by focusing on citation source information and reference source information and classify the electronic documents including the assertion with respect to the proposition into groups based on the determination result on the sameness. Therefore, it is possible to obtain a document group in which an assertion standpoint with respect to a proposition and a ground for the assertion are the same between documents constituting the document group without using an expression concerning opinions or grounds, etc., in a document.

(6) The document analyzing system has a document attribute input unit (realized by, e.g., the proposition relevant document group registration unit 301) that inputs document attribute information (e.g., proposition relevant document meta information) representing the attribute of an electronic document including an assertion with respect to a proposition. The assertion ground determination unit determines whether citation source documents cited in electronic documents are common or not based on the document attribute information input by the document attribute input unit as well as determines whether reference source documents referred to when electronic documents are created are common or not based on the document attribute information input by the document attribute input unit. When determining that at least one of citation source documents and reference source documents are common, the assertion ground determination unit may determine that a ground for the assertion with respect to a proposition is the same. With such a configuration, it is possible to easily determine whether citation source documents cited in electronic documents are common or not and easily determine whether reference source documents referred to when electronic documents are created are common or not based on the document attribute information representing the attribute of an electronic document and thereby to easily determine whether a ground for the assertion with respect to a proposition is the same.

(7) In the document analyzing system, the assertion ground determination unit may determine whether a ground for the assertion with respect to a proposition is the same based on whether at least one of citation source documents further citing a citation source document or reference source document and reference source documents further referred to when a citation source document or reference source document is created are common or not. With such a configuration, it is possible to achieve grouping of electronic documents including an assertion with respect to a proposition with accuracy based on documents recursively cited or referred to.

(8) In the document analyzing system, the assertion ground determination unit may generate a group (e.g., releasing information group) including, as proposition relevant documents relevant to a proposition, electronic documents in which a ground for the assertion with respect to a proposition has been determined to be the same.

(9) The document analyzing system may include an output unit (realized by e.g., the proposition relevant document group output unit 303) that extracts, when a user specifies a specified citation source document or reference source document, a group including proposition relevant documents whose assertion with respect to a proposition has been determined to be the same based on the specified citation source or reference source document from among the plurality of groups that the assertion ground determination unit has generated from the electronic documents including an assertion with respect to a proposition and excludes the extracted group from the output. With such a configuration using the specification information previously specifying the citation source information or reference source information, it is possible to save the effort of outputting a group including unnecessary proposition relevant document.

(10) In the document analyzing system, the output unit may extract, when a user specifies a specified citation source document or reference source document, only a group including proposition relevant documents whose assertion with respect to a proposition has been determined to be the same based on the specified citation source or reference source document from among the plurality of groups generated from the electronic documents including an assertion with respect to a proposition and outputs the extracted group. With such a configuration, it is possible to output only a group including a necessary proposition relevant document according to the specification information previously specifying the citation source information or reference source information, thereby improving processing efficiency.

Although the present invention has been described in detail with reference to the above exemplary embodiment and example, it should be understood that the present invention is not limited to the above exemplary embodiments and examples. Thus, Various changes that can be appreciated by those skilled in the art may be made to the configuration and details of the present invention in the technical scope of the present invention.

The present invention contains subject matter related to Japanese Patent Application JP 2007-272365 filed in Japanese Patent Office on Oct. 19, 2007, the entire contents of which being incorporated herein by reference.

### INDUSTRIAL APPLICABILITY

The present invention can be applied to analyzing systems of various purposes involving document analysis based on an electronic document including opinions or contents of the ground with respect to a given proposition. For example, the present invention can be applied to an information reliability determination support system that determines the reliability of information included in an electronic document, an opinion analyzing system that analyzes an opinion included in an electronic document, and a reputation analyzing system that analyzes the reputation with respect to an electronic document.

1-10. (canceled)

11. A document analyzing system comprising:
an assertion ground determination unit that determines whether a ground for the assertion with respect to a proposition is the same or not based on whether citation source documents in the form of an electronic document cited in electronic documents are common or not, wherein
based on the determination result, the document analyzing system combines electronic documents including an assertion standpoint with respect to a given proposition, between which the assertion standpoint on whether to affirm or deny the proposition or whether to be in a neutral standpoint with respect to the proposition and a ground for the assertion standpoint are the same, into one group.

12. The document analyzing system according to claim 11, comprising a document attribute input unit that inputs document attribute information representing the attribute of an electronic document including an assertion with respect to a proposition, wherein
the assertion ground determination unit determines whether citation source documents cited in electronic documents are common or not based on the document attribute information input by the document attribute input unit and, when determining that the citation source documents cited in electronic documents are common, determines that a ground for the assertion with respect to a proposition is the same.

13. A document analyzing system comprising:
an assertion ground determination unit that determines whether a ground for the assertion with respect to a proposition is the same or not based on whether reference source documents in the form of an electronic document referred to when electronic documents are created are common or not, wherein
based on the determination result, the document analyzing system combines electronic documents including an assertion with respect to a given proposition, between which the assertion standpoint on whether to affirm or deny the proposition or whether to be in a neutral standpoint with respect to the proposition and a ground for the assertion standpoint are the same, into one group.

14. The document analyzing system according to claim 13, comprising a document attribute input unit that inputs document attribute information representing the attribute of an electronic document including an assertion with respect to a proposition, wherein
the assertion ground determination unit determines whether reference source documents referred to when electronic documents are created are common or not based on the document attribute information input by the document attribute input unit and, when determining that the reference source documents referred to when electronic documents are created are common, determines that a ground for the assertion with respect to a proposition is the same.

15. A document analyzing system comprising:
an assertion ground determination unit that determines whether a ground for the assertion with respect to a proposition is the same or not based on whether at least one of citation source documents in the form of an electronic document cited in electronic documents and reference source documents in the form of an electronic document referred to when electronic documents are created are common or not, wherein
based on the determination result, the document analyzing system combines electronic documents including an assertion with respect to a given proposition, between which the assertion standpoint on whether to affirm or deny the proposition or whether to be in a neutral standpoint with respect to the proposition and a ground for the assertion standpoint are the same, into one group.

16. The document analyzing system according to claim 15, comprising a document attribute input unit that inputs document attribute information representing the attribute of an electronic document including an assertion with respect to a proposition, wherein
the assertion ground determination unit determines whether citation source documents cited in electronic documents are common or not based on the document attribute information input by the document attribute input unit as well as determines whether reference source documents referred to when electronic documents are created are common or not based on the document attribute information input by the document attribute input unit, and, when determining that at least one of the citation source documents and reference source documents are common, determines that a ground for the assertion with respect to a proposition is the same.

17. The document analyzing system according to claim 15, wherein
the assertion ground determination unit determines whether a ground for the assertion with respect to a proposition is the same or not based on whether at least one of citation source documents further citing a citation source document or reference source document and reference source documents further referred to when a citation source document or reference source document is created are common or not.

18. The document analyzing system according to claim 15, wherein
the assertion ground determination unit generates a group including, as proposition relevant documents relevant to a proposition, electronic documents in which a ground for the assertion with respect to a proposition has been determined to be the same.

19. The document analyzing system according to claim 18, comprising an output unit that extracts, when a user specifies a specified citation source document or reference source document, a group including proposition relevant documents whose assertion with respect to a proposition has been determined to be the same based on the specified citation source document or reference source document from among the plurality of groups that the assertion ground determination unit has generated from the electronic documents including an assertion with respect to a proposition and excludes the extracted releasing information group from the output.

20. The document analyzing system according to claim 18, wherein
the output unit extracts, when a user specifies a specified citation source document or reference source document, only a group including proposition relevant documents whose assertion with respect to a proposition has been determined to be the same based on the specified citation source document or reference source document from among the plurality of groups generated from the electronic documents including an assertion with respect to a proposition and outputs the extracted group.

21-30. (canceled)
